(19) United States
(12) Patent Application Publication
(10) Pub. No.: US 2016/0037577 A1
(43) Pub. Date: Feb. 4, 2016

(54) MULTICARRIER DISCONTINUOUS COMMUNICATION MANAGEMENT

(71) Applicant: QUALCOMM Incorporated, San Diego, CA (US)

(72) Inventors: Sitaramanjaneyulu KANAMARLAPUDI, San Diego, CA (US); Liangchi HSU, San Diego, CA (US); Arjun BHARADWAJ, San Diego, CA (US)

(21) Appl. No.: 14/581,684

(22) Filed: Dec. 23, 2014

Related U.S. Application Data
(60) Provisional application No. 62/031,042, filed on Jul. 30, 2014.

(51) Int. Cl. H04W 76/04; H04W 52/02; H04W 72/04

(52) U.S. Cl. CPC H04W 76/048; H04W 72/0406; H04W 52/0222

(57) ABSTRACT

An example method may include receiving, at a user equipment (UE), data on a primary carrier supported by the UE, wherein the UE exits a discontinuous reception (DRX) mode in response to receiving the data. Further, the example method may include determining from the data an indication at the UE that handling of one or more secondary carriers also supported by the UE is to be reactivated, wherein the handling of the one or more secondary carriers was deactivated at the UE when the primary carrier entered the DRX mode. In addition, the example method may include activating, at the UE, handling of the one or more secondary carriers in response to the indication.

### CROSS-REFERENCE

This is an application claiming priority to Provisional Application No. 62/031,042 entitled “MULTICARRIER DTX DRX ENHANCEMENT” filed Jul. 30, 2014, and assigned to the assignee hereof and hereby expressly incorporated by reference herein.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

A user equipment (UE) may support multicarrier communication with a network. The use of multicarrier communication may include a primary band including one or more primary carriers and a secondary band including one or more secondary carriers. When the UE operates in a multicarrier discontinuous reception (DRX) mode, the secondary carriers are deactivated as soon as the UE enters the DRX mode but will be reactivated upon data reception on the primary carriers regardless of the amount of received data. As such, the secondary carriers may be reactivated even when the amount of data received is relatively small and therefore impact the battery performance by having additional carriers activated even for small amounts of data.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents examples of techniques for multicarrier discontinuous communication management. An example method may include receiving, at a UE, data on a primary carrier supported by the UE, wherein the UE is configured to exit a DRX mode in response to receiving the data. Further, the example method may include determining from the data an indication at the UE that handling of one or more secondary carriers also supported by the UE is to be reactivated, wherein the handling of the one or more secondary carriers was deactivated at the UE when the primary carrier entered the DRX mode. In addition, the example method may include activating, at the UE, handling of the one or more secondary carriers in response to the determining the indication.

An example apparatus may include means for receiving, at a UE, data on a primary carrier supported by the UE, wherein the UE s configured to exit a DRX mode in response to receiving the data. Further, the example apparatus may include means for determining from the data an indication at the UE that handling of one or more secondary carriers also supported by the UE is to be reactivated, wherein the handling of the one or more secondary carriers was deactivated at the UE when the primary carrier entered the DRX mode. In addition, the example apparatus may include means for activating, at the UE, handling of the one or more secondary carriers in response to the determining the indication.

An example computer-readable medium storing computer executable code for multicarrier discontinuous communication management may include code for receiving, at a UE, data on a primary carrier supported by the UE, wherein the UE s configured to exit a DRX mode in response to receiving the data. Further, the example computer-readable medium may include code for determining from the data an indication at the UE that handling of one or more secondary carriers also supported by the UE is to be reactivated, wherein the handling of the one or more secondary carriers was deactivated at the UE when the primary carrier entered the DRX mode. In addition, the example computer-readable medium may include code for activating, at the UE, handling of the one or more secondary carriers in response to the determining the indication.

Another example apparatus may include a communication component configured to receive, at a UE, data on a primary carrier supported by the UE, wherein the UE s configured to exit a DRX mode in response to receiving the data. Further, the example apparatus may include an indication determination component configured to determine from the data an indication at the UE that handling of one or more secondary carriers also supported by the UE is to be reactivated, wherein the handling of the one or more secondary carriers was deactivated at the UE when the primary carrier entered the DRX mode. Further, the example apparatus may include an activation component configured to activate, at the UE, handling of the one or more secondary carriers in response to the determining the indication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating a wireless communication system, in which multicarrier discontinuous communication management may be implemented;

FIG. 2 is a block diagram illustrating DRX cycles on one or more carriers, in which multicarrier discontinuous communication management may be implemented;

FIG. 3 is a block diagram illustrating a frame structure, by which multicarrier discontinuous communication management may be implemented;

FIG. 4 is a flow chart of aspects of a method of multicarrier discontinuous communication management;

FIG. 5 is a block diagram illustrating an example of a hardware implementation for an apparatus employing a processing system, in which multicarrier discontinuous communication management may be implemented;

FIG. 6 is a block diagram conceptually illustrating an example of a telecommunications system, in which multicarrier discontinuous communication management may be implemented;

FIG. 7 is a conceptual diagram illustrating an example of an access network, in which multicarrier discontinuous communication management may be implemented;

FIG. 8 is a conceptual diagram illustrating an example of a radio protocol architecture for the user and control plane, in which multicarrier discontinuous communication management may be implemented; and

FIG. 9 is a block diagram conceptually illustrating an example of a Node B in communication with a UE in a telecommunications system, in which multicarrier discontinuous communication management may be implemented.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

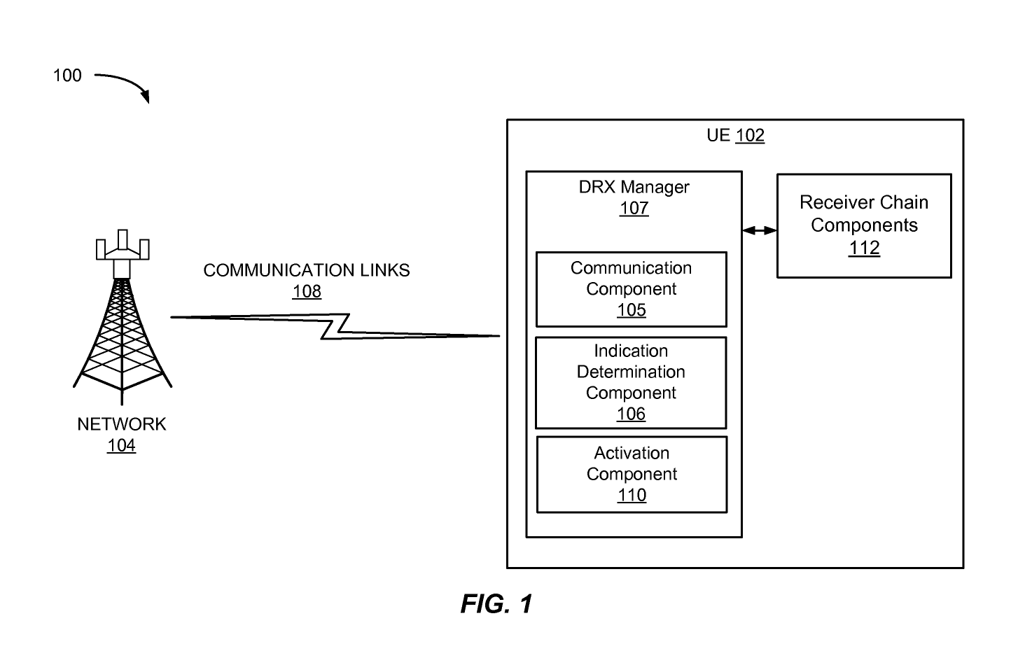

Referring to FIG. 1, a wireless communication system 100 may include a UE 102 having one or more components for multicarrier discontinuous communication management. In an aspect, the term “component” as used herein may be one of the parts that make up a system, may be implemented as hardware, software, firmware, or any combination thereof, and may be further divided into other components. UE 102 may operate in communication with a network 104 over one or more carriers. That is, UE 102 may communicate with network 104 over a primary band including one or more primary carriers and a secondary band including one or more secondary carriers.

In an aspect, UE 102 may operate in DRX mode to reduce power consumption while in communication with network 104. DRX mode may typically include an inactive mode, in which components associated with receiver chains (e.g., receiver chain components 112) may be powered off to reduce power consumption, and an active mode, in which the components associated with the receiver chains may be powered on to receive data from a network. UE 102 may operate in the inactive mode for a portion of a DRX cycle and operate in the active mode for the rest of the DRX cycle and may repeat the operation in multiple DRX cycles until exiting the DRX mode. As referenced herein, a DRX cycle may refer to a cycle of predetermined time duration. That is, while operating in DRX mode, UE 102 may be configured to periodically enter an inactive mode during each of the DRX cycles, in which components associated with receiver chains (e.g., receiver chain components 112) may be powered off to reduce power consumption. Further, UE 102 may periodically exit the inactive mode and operate in the active mode, e.g., powering on the components associated with receiver chains, to receive data from network 104.

In the case of MC-HSPDA, all secondary carriers may be deactivated when UE 102 starts to operate in DRX mode. As such, UE 102 may follow DRX cycles to power on and power off the components associated with receiver chains only on the one or more primary carriers. When UE 102 exits the DRX mode and receives data from network 104, UE 102 may stop operating in the inactive mode and both the primary carriers and the secondary carriers may be activated except for some secondary carriers that have been deactivated by an HS-SCCH order. Network 104 may start scheduling data transmission on the secondary carriers after a specified activation time or may wait for the reception of Channel Quality Indicator (CQI) report on the secondary carriers.

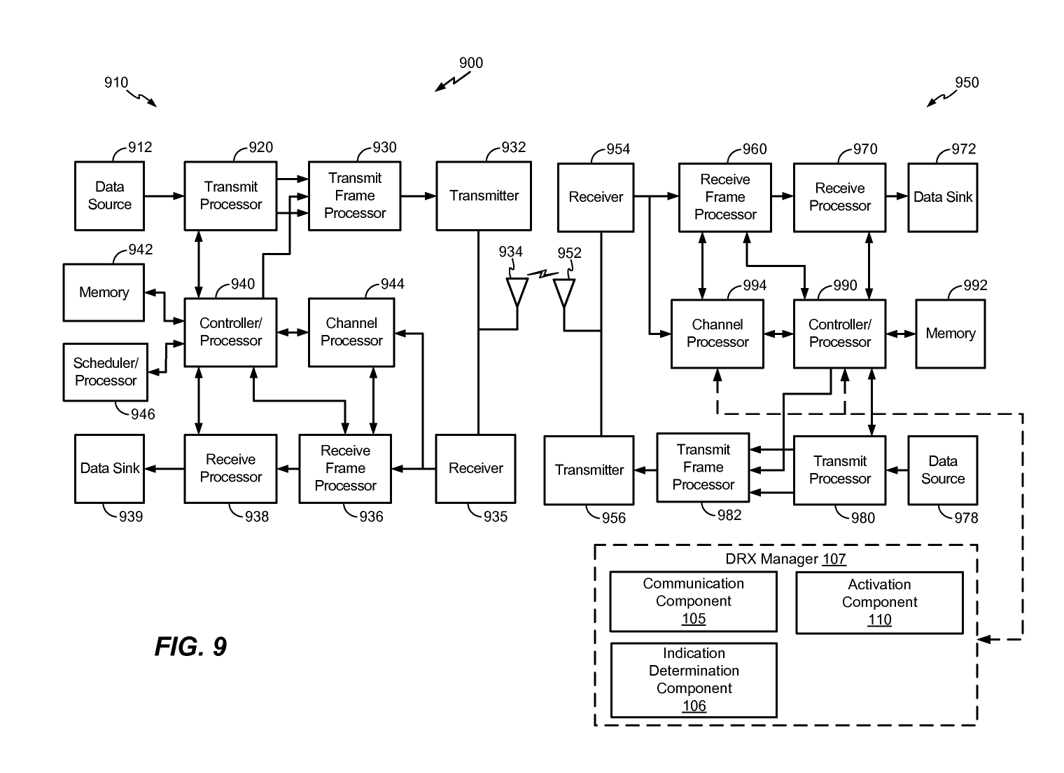

In another aspect, in a case where UE 102 and/or communication component 105 only receives a relatively small amount of data, e.g., less than 42 kbits, from network 104 on the primary carriers, maintaining the secondary carriers as deactivated may save more power than activating all secondary carriers upon reception of any data on the primary carriers. As referenced herein, deactivating the secondary carriers may refer to powering off hardware components that handle the secondary carriers. As such, UE 102 and/or indication determination component 106 may be configured to determine from the data received on the primary carriers an indication to activate the secondary carriers. If the indication can be determined, activation component 110 may be configured to activate the secondary carriers. If UE 102 and/or indication determination component 106 cannot determine the indication, the secondary carriers may be maintained as deactivated even when data is received on the primary carriers. In some examples, communication component 105 may refer to one or more components separate or independent from DRX manager 107, e.g., receiver 954 and/or transmitter 956 of FIG. 9. In some examples, the receiver chain components 112 may be part of the communication component 105.

For example, the indication may refer to a size of the received data that is greater than a size threshold. In other words, UE 102 and/or activation component 110 may activate the secondary carriers when the size of data received on primary carriers exceeds the size threshold. In a non-limiting example, the size threshold may be 42 kbits.

In another example, the indication may refer to an HS-SCCH order received by communication component 105 on one or more of the primary carriers. In accordance with the HS-SCCH order, UE 102 and/or activation component 110 may activate the secondary carriers when an HS-SCCH order indicating that the secondary carriers should be activated is received on the primary carriers. As referenced herein, activating the secondary carriers may refer to powering on the hardware components that handle the secondary carrier.

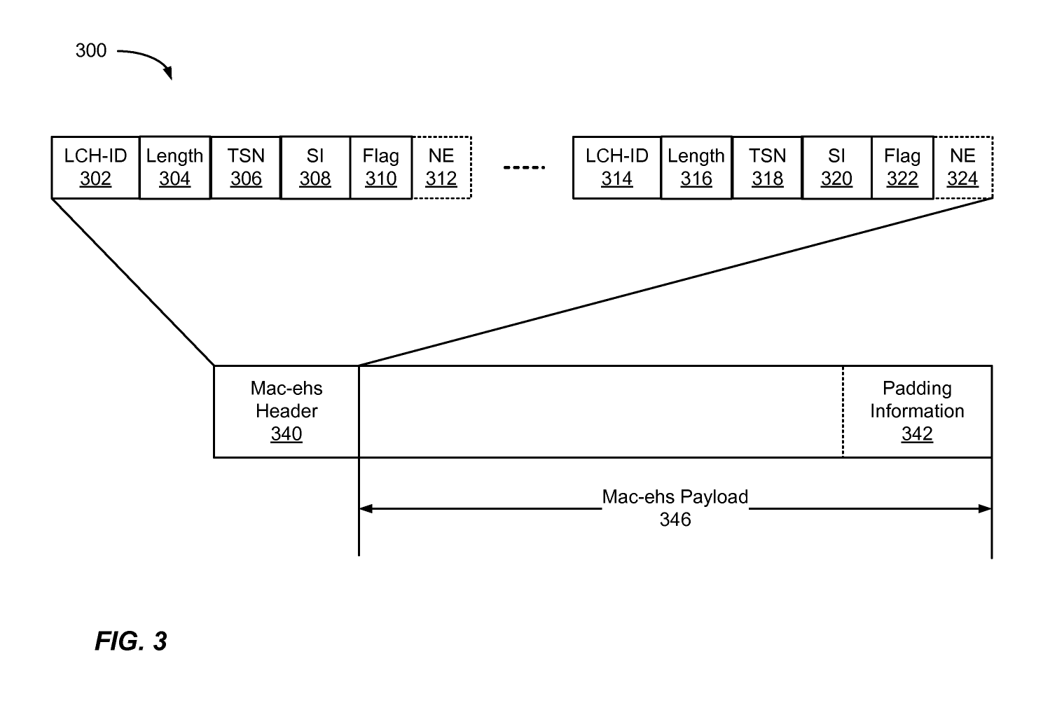

In yet another example, the indication may refer to information included in in-band signaling. For instance, the information may refer to a logical channel identifier (LCH-ID), e.g., when the value of the LCH-ID field in a frame structure (see e.g., frame structure 300 in FIG. 3) is 1111. That is, indication determination component 106 may be configured to determine if an LCH-ID of the received data on the primary carriers is 1111. When the value of LCH-ID is 1111, activation component 110 may be configured to activate the secondary carriers.

For another instance, the information may be included one or more padding bits in the Mac-ehs payload, e.g., padding information 341 in Mac-ehs payload 346. That is, indication determination component 106 may be configured to check and/or decode the padding bits included in the Mac-ehs payload of the received data. If the padding bits indicate that the secondary carriers should be activated, activation component 110 may be configured to activate the secondary carriers.

For yet another instance, the information may be included in one or more additional elements in the Mac-ehs header, e.g., Mac-ehs header 340, of the data received on the primary carriers. That is, indication determination component 106 may be configured to check if the Mac-ehs header includes one or more additional elements that indicate the secondary carriers should be activated. If the Mac-ehs header includes one or more additional elements that indicate the secondary carriers should be activated, activation component 110 may be configured to activate the secondary carriers.

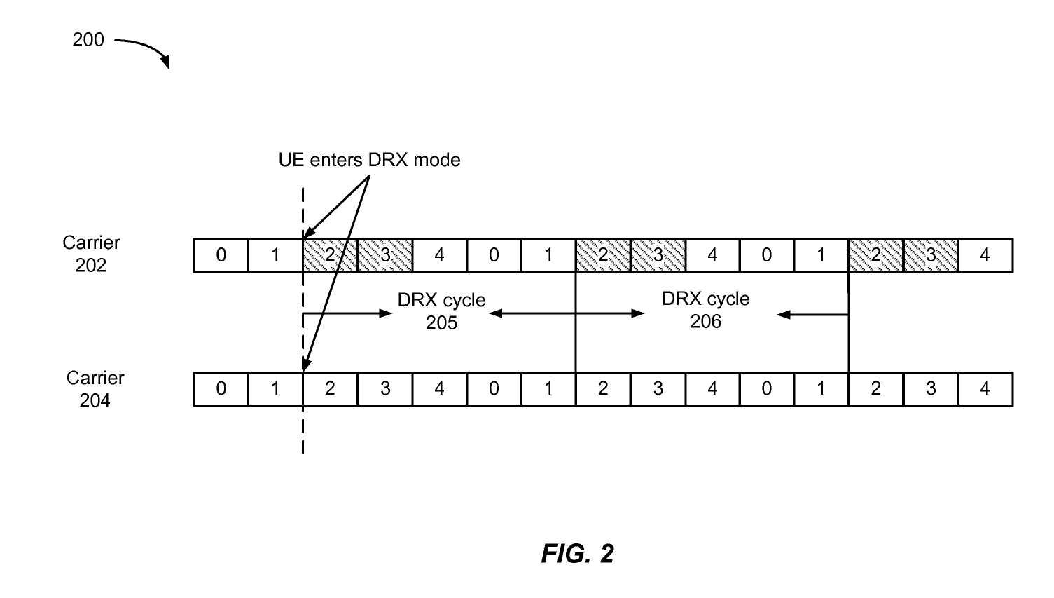

FIG. 2 is a block diagram illustrating DRX cycles on one or more carriers, in which multicarrier discontinuous communication management may be implemented. Carrier 202 may refer to one of the one or more primary carriers and carrier 204 may refer to one of the one or more secondary carriers.

As depicted, UE 102 may start to operate in DRX mode at the beginning of DRX cycle 205 and periodically exit the inactive mode to receive data at the beginning of block “2.” Carrier 202 may be activated during certain time intervals, e.g., hatched blocks marked as “2” and “3,” and may be deactivated during other portions of DRX cycles, e.g., blocks marked as “4,” “0,” and “1.” Note that the blocks are marked as a non-limiting example. Each time interval may refer to a portion of a DRX cycle. Carrier 204 may be deactivated once UE 102 starts to operate in DRX mode, or enters DRX mode unless indication determination component 106 determines that the data received on the primary carriers indicate that the secondary carriers should be activated.

FIG. 3 is a block diagram illustrating a frame structure, by which multicarrier discontinuous communication management may be implemented.

As depicted, the frame structure of the data received on the primary carriers may include a Mac-ehs header 340 and a Mac-ehs payload 346. Mac-ehs header 340 may further include one or more groups of elements. Each group of elements may include a LCH-ID field (e.g., LCH-ID 302 and 314), a length indicator (e.g., length 304 and 316), a transmission sequence number (e.g., TSN 306 and 318), a segmentation indication (SI 308 and 320), a flag (e.g., 310 and 322), and a new element (e.g., NE 312 and 324).

In an aspect, the LCH-ID fields may provide identification of the logic channel at the receiver and a re-ordering buffer destination of a reordering service data unit (SDU). The length indicator may provide the length of the reordering SDU in octets. The TSN may provide an identifier for the transmission sequence number on the high speed downlink shared channel (HS-DSCH). The segmentation indication may indicate if the Mac-ehs SDU has been segmented. The flag may indicate if more fields are present in the Mac-ehs header or not. The new element may include the indication that the secondary carriers should be activated.

In some examples, if one of the LCH-ID fields 302, 314 is set to “1111,” indication determination component 106 may be configured to determine that the secondary carriers should be activated. Activation component 110 may then accordingly activate the secondary carriers. In some other examples, other values may also be determined to indicate that the secondary carriers should be activated.

In some other examples, additionally or alternatively, Mac-ehs payload 346 may include padding information 342. Padding information 342 may also include the indication that the secondary carriers should be activated. As mentioned above, indication determination component 106 may check and/or decode padding information 342 to determine if the secondary carriers should be activated. If so, activation component 110 may accordingly activate the secondary carriers. In an aspect, the number of bits included in padding information 342 may be optional.

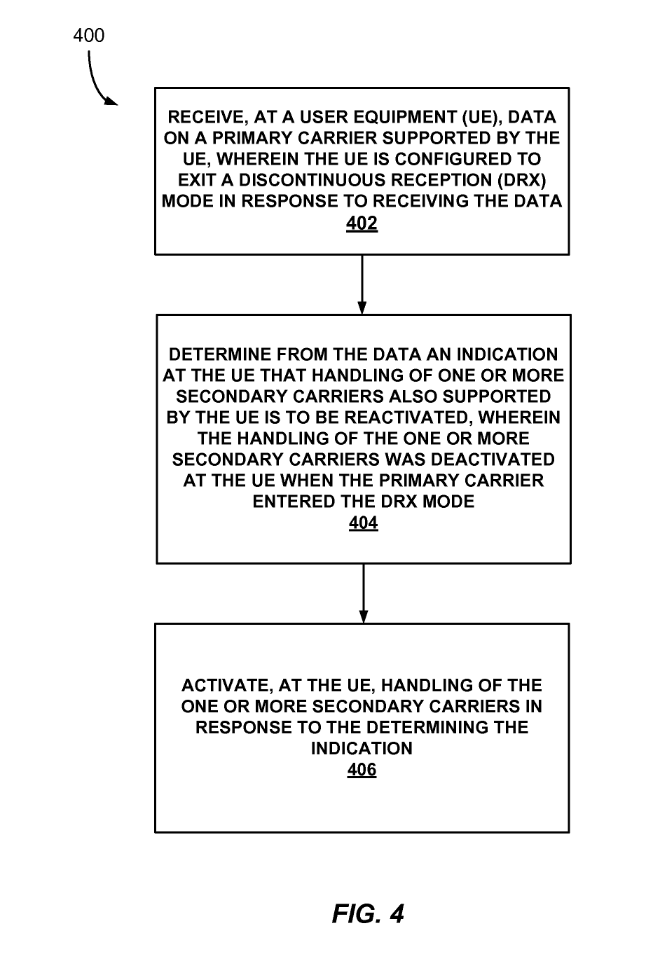

FIG. 4 is a flow chart of aspects of a method of multicarrier discontinuous communication management. In an aspect, UE 102 may perform method 400 in DRX mode. More particularly, aspects of method 400 may be performed by DRX manager 107 that include communication component 105, indication determination component 106, and activation component 110 as shown in FIG. 1.

At 402, method 400 includes receiving, at a UE, data on a primary carrier supported by the UE, wherein the UE exits a DRX mode in response to receiving the data. For example, communication component 105 may be configured to receive data on the primary carriers when UE 102 exits the inactive mode.

At 404, method 400 includes determining from the data an indication at the UE that handling of one or more secondary carriers also supported by the UE is to be reactivated, wherein the handling of the one or more secondary carriers was deactivated at the UE when the primary carrier entered the DRX mode. For example, indication determination component 106 may be configured to determine from the data received on the primary carriers an indication that the handling of the secondary carriers is to be activated or reactivated. As referenced herein, the handling of the secondary carriers may refer to one or more components associated with the secondary carriers, e.g., receiver chains of the secondary carriers. For example, the indication may refer to a size of the received data that is greater than a size threshold. In other words, UE 102 and/or activation component 110 may activate the secondary carriers when the size of data received on primary carriers exceeds the size threshold. In a non-limiting example, the size threshold may be 42 k bits.

In another example, the indication may refer to an HS-SCCH order received by communication component 105 on one or more of the primary carriers. In accordance with the HS-SCCH order, UE 102 and/or activation component 110 may activate the secondary carriers when an HS-SCCH order indicating that the secondary carriers should be activated is received on the primary carriers.

In yet another example, the indication may refer to information included in-band signaling. For instance, the information may refer to a logical channel identifier (LCH-ID), e.g., when the value of the LCH-ID field in a frame structure (see e.g., frame structure 300 in FIG. 3) is 1111. That is, indication determination component 106 may be configured to determine if a LCH-ID of the received data on the primary carriers is 1111. When the value of LCH-ID is 1111, activation component 110 may be configured to activate the secondary carriers.

For another instance, the information may be included one or more padding bits in the Mac-ehs payload, e.g., padding information 341 in Mac-ehs payload 346. That is, indication determination component 106 may be configured to check and/or decode the padding bits included in the Mac-ehs payload of the received data. If the padding bits indicate that the secondary carriers should be activated, activation component 110 may be configured to activate the secondary carriers.

For yet another instance, the information may be included in one or more additional elements in the Mac-ehs header, e.g., Mac-ehs header 340, of the data received on the primary carriers. That is, indication determination component 106 may be configured to check if the Mac-ehs header includes one or more additional elements that indicate the secondary carriers should be activated. If the Mac-ehs header includes one or more additional elements that indicate the secondary carriers should be activated, activation component 110 may be configured to activate the secondary carriers.

At 406, method 400 includes activating, at the UE, handling of the one or more secondary carriers in response to the indication. For example, activation component 110 may be configured to activate or reactivate the handling of the secondary carriers.

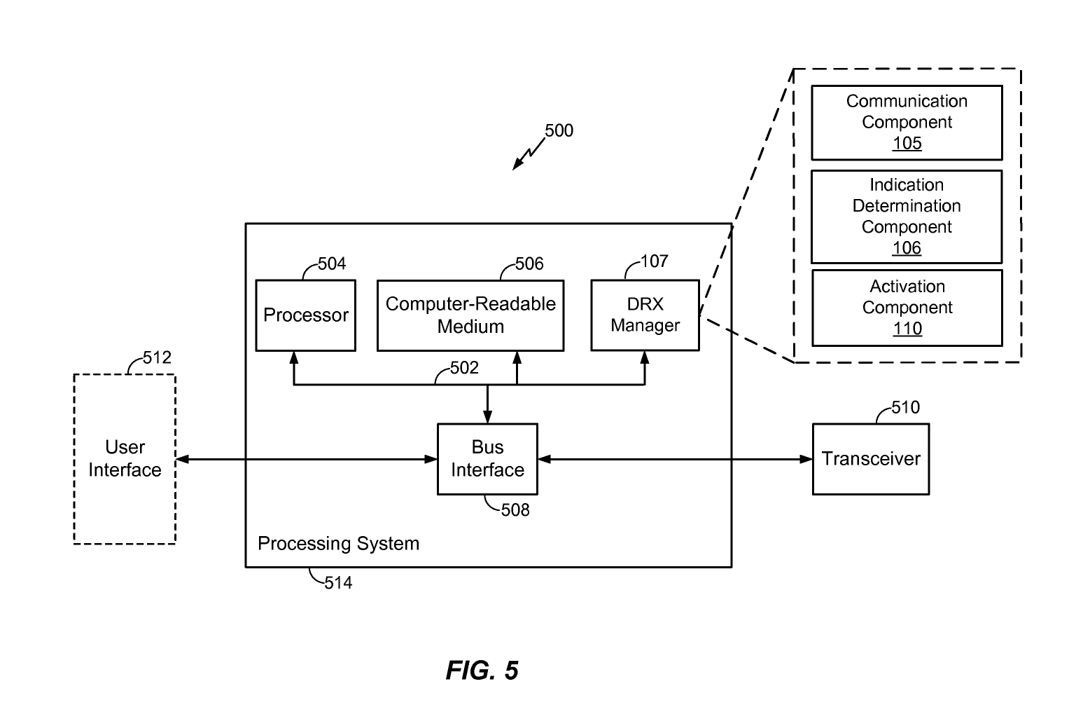

Referring to FIG. 5, an example of a hardware implementation for an apparatus 500 employing a processing system 514 having aspects configured for multicarrier discontinuous communication management. In an aspect, apparatus 500 may be a UE 102 of FIG. 1, including DRX manager 107 having communication component 105, indication determination component 106, and activation component 110.

In this example, the processing system 514 may be implemented with a bus architecture, represented generally by the bus 502. The bus 502 may include any number of interconnecting buses and bridges depending on the specific application of the processing system 514 and the overall design constraints. The bus 502 links together various circuits including one or more processors, represented generally by the processor 504, and computer-readable media, represented generally by the computer-readable medium 506, and one or more components, such as, for example, DRX manager 107 having communication component 105, indication determination component 106, and activation component 110 of FIG. 1. The bus 502 may also link various other circuits such as timing sources, peripherals, voltage regulators, and power management circuits, which are well known in the art, and therefore, will not be described any further. A bus interface 508 provides an interface between the bus 502 and a transceiver 510. The transceiver 510 provides a means for communicating with various other apparatus over a transmission medium. Depending upon the nature of the apparatus, a user interface 512 (e.g., keypad, display, speaker, microphone, joystick) may also be provided.

The processor 504 is responsible for managing the bus 502 and general processing, including the execution of software stored on the computer-readable medium 506. The software, when executed by the processor 504, causes the processing system 514 to perform the various functions described infra for any particular apparatus. The computer-readable medium 506 may also be used for storing data that is manipulated by the processor 504 when executing software, such as, for example, software modules represented by DRX manager 107.

For example, communication component 105 may be configured to receive data on the primary carriers when UE 102 exits the inactive mode. In some examples, communication component 105 may refer to transceiver 510 that is separate and independent from DRX manager 107. Indication determination component 106 may be configured to determine from the data received on the primary carriers an indication that the handling of the secondary carriers is to be activated or reactivated. Activation component 110 may be configured to activate or reactivate the handling of the secondary carriers.

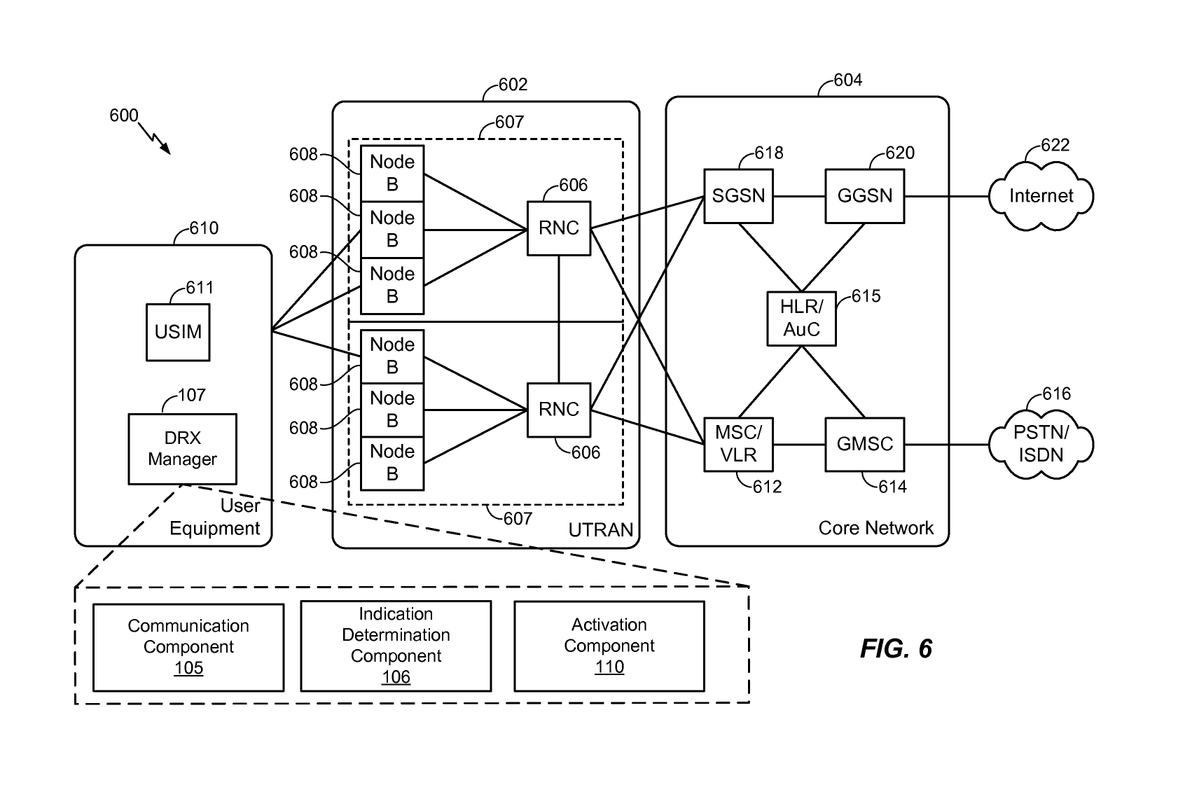

The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system 600 employing a W-CDMA air interface. A UMTS network includes three interacting domains: a Core Network (CN) 604, a UMTS Terrestrial Radio Access Network (UTRAN) 602, and User Equipment (UE) 610. In an aspect, UE 610 may be an example of UE 102 of FIG. 1, including DRX manager 107 having communication component 105, indication determination component 106, and activation component 110. For example, communication component 105 may be configured to receive data on the primary carriers when UE 102 exits the inactive mode. Indication determination component 106 may be configured to determine from the data received on the primary carriers an indication that the handling of the secondary carriers is to be activated or reactivated. Activation component 110 may be configured to activate or reactivate the handling of the secondary carriers.

In this example, the UTRAN 602 provides various wireless services including telephony, video, data, messaging, broadcasts, and/or other services. The UTRAN 602 may include a plurality of Radio Network Subsystems (RNSs) such as an RNS 607, each controlled by a respective Radio Network Controller (RNC) such as an RNC 606. Here, the UTRAN 602 may include any number of RNCs 606 and RNSs 607 in addition to the RNCs 606 and RNSs 607 illustrated herein. The RNC 606 is an apparatus responsible for, among other things, assigning, reconfiguring and releasing radio resources within the RNS 607. The RNC 606 may be interconnected to other RNCs (not shown) in the UTRAN 602 through various types of interfaces such as a direct physical connection, a virtual network, or the like, using any suitable transport network.

Communication between a UE 610 and a Node B 608 may be considered as including a physical (PHY) layer and a medium access control (MAC) layer. Further, communication between a UE 610 and an RNC 606 by way of a respective Node B 608 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 607 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 608 are shown in each RNS 607; however, the RNSs 607 may include any number of wireless Node Bs. The Node Bs 608 provide wireless access points to a CN 604 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 610 may further include a universal subscriber identity module (USIM) 611, which contains a user's subscription information to a network. For illustrative purposes, one UE 610 is shown in communication with a number of the Node Bs 608. The DL, also called the forward link, refers to the communication link from a Node B 608 to a UE 610, and the UL, also called the reverse link, refers to the communication link from a UE 610 to a Node B 608.

The CN 604 interfaces with one or more access networks, such as the UTRAN 602. As shown, the CN 604 is a GSM core network. However, as those skilled in the art will recognize, the various concepts presented throughout this disclosure may be implemented in a RAN, or other suitable access network, to provide UEs with access to types of CNs other than GSM networks.

The CN 604 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 604 supports circuit-switched services with a MSC 612 and a GMSC 614. In some applications, the GMSC 614 may be referred to as a media gateway (MGW). One or more RNCs, such as the RNC 606, may be connected to the MSC 612. The MSC 612 is an apparatus that controls call setup, call routing, and UE mobility functions. The MSC 612 also includes a VLR that contains subscriber-related information for the duration that a UE is in the coverage area of the MSC 612. The GMSC 614 provides a gateway through the MSC 612 for the UE to access a circuit-switched network 616. The GMSC 614 includes a home location register (HLR) 615 containing subscriber data, such as the data reflecting the details of the services to which a particular user has subscribed. The HLR is also associated with an authentication center (AuC) that contains subscriber-specific authentication data. When a call is received for a particular UE, the GMSC 614 queries the HLR 615 to determine the UE's location and forwards the call to the particular MSC serving that location.

The CN 604 also supports packet-data services with a serving GPRS support node (SGSN) 618 and a gateway GPRS support node (GGSN) 620. GPRS, which stands for General Packet Radio Service, is designed to provide packet-data services at speeds higher than those available with standard circuit-switched data services. The GGSN 620 provides a connection for the UTRAN 602 to a packet-based network 622. The packet-based network 622 may be the Internet, a private data network, or some other suitable packet-based network. The primary function of the GGSN 620 is to provide the UEs 610 with packet-based network connectivity. Data packets may be transferred between the GGSN 620 and the UEs 610 through the SGSN 618, which performs primarily the same functions in the packet-based domain as the MSC 612 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 608 and a UE 610. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 610 provides feedback to the node B 608 over the HS-DPCCH to indicate whether it correctly decoded a packet on the downlink.

HS-DPCCH further includes feedback signaling from the UE 610 to assist the node B 608 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 608 and/or the UE 610 may have multiple antennas supporting MIMO technology. The use of MIMO technology enables the node B 608 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 610 to increase the data rate or to multiple UEs 610 to increase the overall system capacity. This is achieved by spatially precoding each data stream and then transmitting each spatially precoded stream through a different transmit antenna on the downlink. The spatially precoded data streams arrive at the UE(s) 610 with different spatial signatures, which enables each of the UE(s) 610 to recover the one or more the data streams destined for that UE 610. On the uplink, each UE 610 may transmit one or more spatially precoded data streams, which enables the node B 608 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

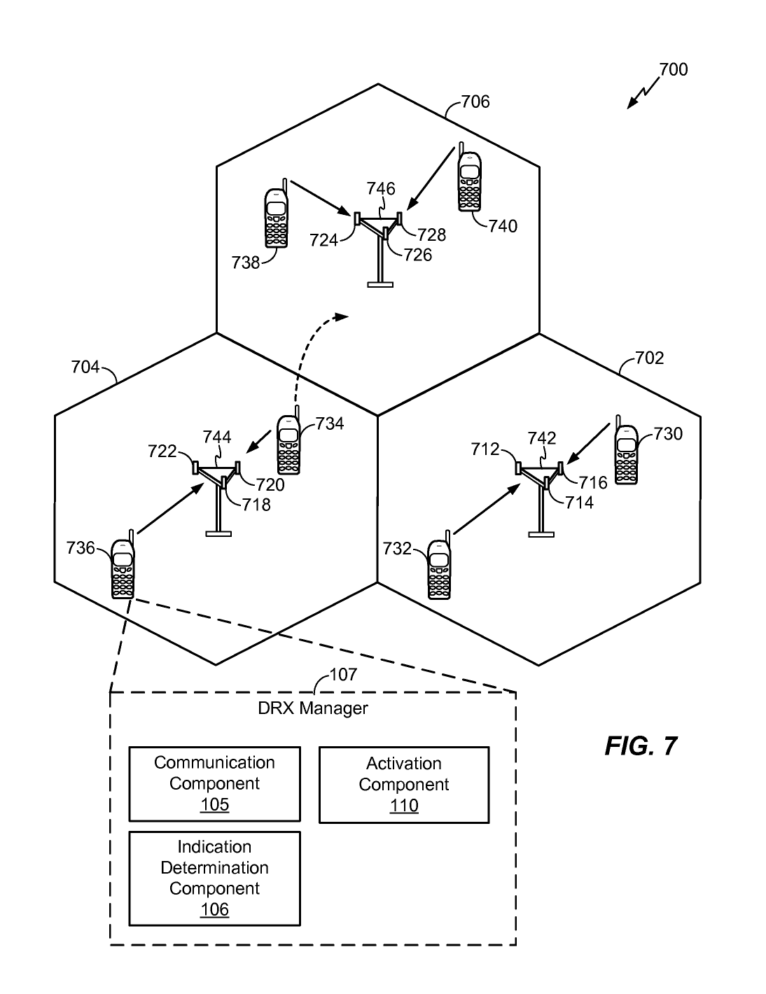

Referring to FIG. 7, an access network 700 in a UTRAN architecture is illustrated. The multiple access wireless communication system includes multiple cellular regions (cells), including cells 702, 704, and 706, each of which may include one or more sectors. The multiple sectors can be formed by groups of antennas with each antenna responsible for communication with UEs in a portion of the cell. For example, in cell 702, antenna groups 712, 714, and 716 may each correspond to a different sector. In cell 704, antenna groups 718, 720, and 722 each correspond to a different sector. In cell 706, antenna groups 724, 726, and 728 each correspond to a different sector. The cells 702, 704 and 706 may include several wireless communication devices, e.g., User Equipment or UEs, which may be in communication with one or more sectors of each cell 702, 704 or 706. For example, UEs 730 and 732 may be in communication with Node B 742, UEs 734 and 736 may be in communication with Node B 744, and UEs 738 and 740 can be in communication with Node B 746. Here, each Node B 742, 744, 746 is configured to provide an access point to a CN 604 (see FIG. 6) for all the UEs 730, 732, 734, 736, 738, 740 in the respective cells 702, 704, and 706. In an aspect, one of UEs 730, 732, 734, 736, 738, and 740 may be an example of UE 102 of FIG. 1, including DRX manager 107 having communication component 105, indication determination component 106, and activation component 110. For example, communication component 105 may be configured to receive data on the primary carriers when UE 102 exits the inactive mode. Indication determination component 106 may be configured to determine from the data received on the primary carriers an indication that the handling of the secondary carriers is to be activated or reactivated. Activation component 110 may be configured to activate or reactivate the handling of the secondary carriers.

As the UE 734 moves from the illustrated location in cell 704 into cell 706, a serving cell change (SCC) or handover may occur in which communication with the UE 734 transitions from the cell 704, which may be referred to as the source cell, to cell 706, which may be referred to as the target cell. Management of the handover procedure may take place at the UE 734, at the Node Bs corresponding to the respective cells, at a radio network controller 606 (see FIG. 6), or at another suitable node in the wireless network. For example, during a call with the source cell 704, or at any other time, the UE 734 may monitor various parameters of the source cell 704 as well as various parameters of neighboring cells such as cells 706 and 702. Further, depending on the quality of these parameters, the UE 734 may maintain communication with one or more of the neighboring cells. During this time, the UE 734 may maintain an Active Set, that is, a list of cells that the UE 734 is simultaneously connected to (i.e., the UTRA cells that are currently assigning a downlink dedicated physical channel DPCH or fractional downlink dedicated physical channel F-DPCH to the UE 734 may constitute the Active Set).

The modulation and multiple access scheme employed by the access network 700 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

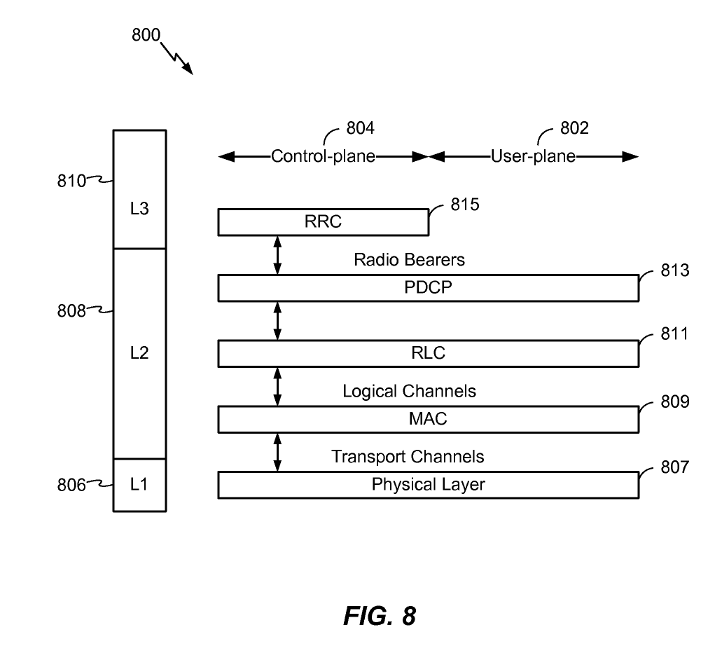

The radio protocol architecture may take on various forms depending on the particular application. An example for an HSPA system will now be presented with reference to FIG. 8.

Referring to FIG. 8 an example radio protocol architecture 800 relates to the user plane 802 and the control plane 804 of a user equipment (UE) or node B/base station. For example, architecture 800 may be included in a UE such as UE 102 of FIG. 1, including DRX manager 107 having communication component 105, indication determination component 106, and activation component 110. For example, communication component 105 may be configured to receive data on the primary carriers when UE 102 exits the inactive mode. Indication determination component 106 may be configured to determine from the data received on the primary carriers an indication that the handling of the secondary carriers is to be activated or reactivated. Activation component 110 may be configured to activate or reactivate the handling of the secondary carriers.

The radio protocol architecture 800 for the UE and node B is shown with three layers: Layer 1 806, Layer 2 808, and Layer 3 810. Layer 1 806 is the lowest lower and implements various physical layer signal processing functions. As such, Layer 1 806 includes the physical layer 807. Layer 2 (L2 layer) 808 is above the physical layer 807 and is responsible for the link between the UE and node B over the physical layer 807. Layer 3 (L3 layer) 810 includes a radio resource control (RRC) sublayer 815. The RRC sublayer 815 handles the control plane signaling of Layer 3 between the UE and the UTRAN.

In the user plane, the L2 layer 808 includes a media access control (MAC) sublayer 809, a radio link control (RLC) sublayer 811, and a packet data convergence protocol (PDCP) 813 sublayer, which are terminated at the node B on the network side. Although not shown, the UE may have several upper layers above the L2 layer 808 including a network layer (e.g., IP layer) that is terminated at a PDN gateway on the network side, and an application layer that is terminated at the other end of the connection (e.g., far end UE, server, etc.).

The PDCP sublayer 813 provides multiplexing between different radio bearers and logical channels. The PDCP sublayer 813 also provides header compression for upper layer data packets to reduce radio transmission overhead, security by ciphering the data packets, and handover support for UEs between node Bs. The RLC sublayer 811 provides segmentation and reassembly of upper layer data packets, retransmission of lost data packets, and reordering of data packets to compensate for out-of-order reception due to hybrid automatic repeat request (HARQ). The MAC sublayer 809 provides multiplexing between logical and transport channels. The MAC sublayer 809 is also responsible for allocating the various radio resources (e.g., resource blocks) in one cell among the UEs. The MAC sublayer 809 is also responsible for HARQ operations.

FIG. 9 is a block diagram of a Node B 910 in communication with a UE 950, where the Node B 910 may be an example of a base station associated with network 104 of FIG. 1, and the UE 950 may be the UE 102 of FIG. 1, including DRX manager 107 having communication component 105, indication determination component 106, and activation component 110. For example, communication component 105 may be configured to receive data on the primary carriers when UE 102 exits the inactive mode. Indication determination component 106 may be configured to determine from the data received on the primary carriers an indication that the handling of the secondary carriers is to be activated or reactivated. Activation component 110 may be configured to activate or reactivate the handling of the secondary carriers. In the downlink communication, a transmit processor 920 may receive data from a data source 912 and control signals from a controller/processor 940. The transmit processor 920 provides various signal processing functions for the data and control signals, as well as reference signals (e.g., pilot signals). For example, the transmit processor 920 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 944 may be used by a controller/processor 940 to determine the coding, modulation, spreading, and/or scrambling schemes for the transmit processor 920. These channel estimates may be derived from a reference signal transmitted by the UE 950 or from feedback from the UE 950. The symbols generated by the transmit processor 920 are provided to a transmit frame processor 930 to create a frame structure. The transmit frame processor 930 creates this frame structure by multiplexing the symbols with information from the controller/processor 940, resulting in a series of frames. The frames are then provided to a transmitter 932, which provides various signal conditioning functions including amplifying, filtering, and modulating the frames onto a carrier for downlink transmission over the wireless medium through antenna 934. The antenna 934 may include one or more antennas, for example, including beam steering bidirectional adaptive antenna arrays or other similar beam technologies.

At the UE 950, a receiver 954 receives the downlink transmission through an antenna 952 and processes the transmission to recover the information modulated onto the carrier. The information recovered by the receiver 954 is provided to a receive frame processor 960, which parses each frame, and provides information from the frames to a channel processor 994 and the data, control, and reference signals to a receive processor 970. The receive processor 970 then performs the inverse of the processing performed by the transmit processor 920 in the Node B 910. More specifically, the receive processor 970 descrambles and despreads the symbols, and then determines the most likely signal constellation points transmitted by the Node B 910 based on the modulation scheme. These soft decisions may be based on channel estimates computed by the channel processor 994. The soft decisions are then decoded and deinterleaved to recover the data, control, and reference signals. The CRC codes are then checked to determine whether the frames were successfully decoded. The data carried by the successfully decoded frames will then be provided to a data sink 972, which represents applications running in the UE 950 and/or various user interfaces (e.g., display). Control signals carried by successfully decoded frames will be provided to a controller/processor 990. When frames are unsuccessfully decoded by the receiver processor 970, the controller/processor 990 may also use an acknowledgement (ACK) and/or negative acknowledgement (NACK) protocol to support retransmission requests for those frames.

In the uplink, data from a data source 978 and control signals from the controller/processor 990 are provided to a transmit processor 980. The data source 978 may represent applications running in the UE 950 and various user interfaces (e.g., keyboard). Similar to the functionality described in connection with the downlink transmission by the Node B 910, the transmit processor 980 provides various signal processing functions including CRC codes, coding and interleaving to facilitate FEC, mapping to signal constellations, spreading with OVSFs, and scrambling to produce a series of symbols. Channel estimates, derived by the channel processor 994 from a reference signal transmitted by the Node B 910 or from feedback contained in the midamble transmitted by the Node B 910, may be used to select the appropriate coding, modulation, spreading, and/or scrambling schemes. The symbols produced by the transmit processor 980 will be provided to a transmit frame processor 982 to create a frame structure. The transmit frame processor 982 creates this frame structure by multiplexing the symbols with information from the controller/processor 990, resulting in a series of frames. The frames are then provided to a transmitter 956, which provides various signal conditioning functions including amplification, filtering, and modulating the frames onto a carrier for uplink transmission over the wireless medium through the antenna 952.

The uplink transmission is processed at the Node B 910 in a manner similar to that described in connection with the receiver function at the UE 950. A receiver 935 receives the uplink transmission through the antenna 934 and processes the transmission to recover the information modulated onto the carrier. The information recovered by the receiver 935 is provided to a receive frame processor 936, which parses each frame, and provides information from the frames to the channel processor 944 and the data, control, and reference signals to a receive processor 938. The receive processor 938 performs the inverse of the processing performed by the transmit processor 980 in the UE 950. The data and control signals carried by the successfully decoded frames may then be provided to a data sink 939 and the controller/processor, respectively. If some of the frames were unsuccessfully decoded by the receive processor, the controller/processor 940 may also use an acknowledgement (ACK) and/or negative acknowledgement (NACK) protocol to support retransmission requests for those frames.

The controller/processors 940 and 990 may be used to direct the operation at the Node B 910 and the UE 950, respectively. For example, the controller/processors 940 and 990 may provide various functions including timing, peripheral interfaces, voltage regulation, power management, and other control functions. The computer readable media of memories 942 and 992 may store data and software for the Node B 910 and the UE 950, respectively. A scheduler/processor 946 at the Node B 910 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: at least one a; at least one b; at least one c; at least one a and at least one b; at least one a and at least one c; at least one b and at least one c; and at least one a, at least one b and at least one c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for multicarrier discontinuous communication management, comprising:
receiving, at a user equipment (UE), data on a primary carrier supported by the UE, wherein the UE is configured to exit a discontinuous reception (DRX) mode in response to receiving the data;
determining from the data an indication at the UE that handling of one or more secondary carriers also supported by the UE is to be reactivated, wherein the handling of the one or more secondary carriers was deactivated at the UE when the primary carrier entered the DRX mode; and
activating, at the UE, handling of the one or more secondary carriers in response to the determining the indication.

2. The method of claim 1, wherein the indication is that a size of the received data is greater than a size threshold.

3. The method of claim 1, wherein the indication is a high speed shared control channel (HS-SCCH) order.

4. The method of claim 1, wherein the indication includes a logical channel identifier that indicates to the UE to activate the one or more secondary carriers.

5. The method of claim 1, wherein the indication includes one or more padding bits that indicate to the UE to activate the one or more secondary carriers.

6. The method of claim 1, wherein the indication includes a header element that indicates to the UE to activate the one or more secondary carriers.

7. An apparatus for multicarrier discontinuous communication management, comprising:
means for receiving, at a user equipment (UE), data on a primary carrier supported by the UE, wherein the UE is configured to exit a discontinuous reception (DRX) mode in response to receiving the data;
means for determining from the data an indication at the UE that handling of one or more secondary carriers also supported by the UE is to be reactivated, wherein the handling of the one or more secondary carriers was deactivated at the UE when the primary carrier entered the DRX mode; and
means for activating, at the UE, handling of the one or more secondary carriers in response to the determining the indication.

8. The apparatus of claim 7, wherein the indication is that a size of the received data is greater than a size threshold.

9. The apparatus of claim 7, wherein the indication is a high speed shared control channel (HS-SCCH) order.

10. The apparatus of claim 7, wherein the indication includes a logical channel identifier that indicates to the UE to activate the one or more secondary carriers.

11. The apparatus of claim 7, wherein the indication includes one or more padding bits that indicate to the UE to activate the one or more secondary carriers.

12. The apparatus of claim 7, wherein the indication includes a header element that indicates to the UE to activate the one or more secondary carriers.

13. A computer-readable medium storing computer executable code for multicarrier discontinuous communication management, comprising:
code for receiving, at a user equipment (UE), data on a primary carrier supported by the UE, wherein the UE is configured to exit a discontinuous reception (DRX) mode in response to receiving the data;
code for determining from the data an indication at the UE that handling of one or more secondary carriers also supported by the UE is to be reactivated, wherein the handling of the one or more secondary carriers was deactivated at the UE when the primary carrier entered the DRX mode; and
code for activating, at the UE, handling of the one or more secondary carriers in response to the determining the indication.

14. The computer-readable medium of claim 13, wherein the indication is that a size of the received data is greater than a size threshold.

15. The computer-readable medium of claim 13, wherein the indication is a high speed shared control channel (HS-SCCH) order.

16. The computer-readable medium of claim 13, wherein the indication includes a logical channel identifier that indicates to the UE to activate the one or more secondary carriers.

17. The computer-readable medium of claim 13, wherein the indication includes one or more padding bits that indicate to the UE to activate the one or more secondary carriers.

18. The computer-readable medium of claim 13, wherein the indication includes a header element that indicates to the UE to activate the one or more secondary carriers.

19. An apparatus for multicarrier discontinuous communication management, comprising:
a communication component configured to receive, at a user equipment (UE), data on a primary carrier supported by the UE, wherein the UE is configured to exit a discontinuous reception (DRX) mode in response to receiving the data;
an indication determination component configured to determine from the data an indication at the UE that handling of one or more secondary carriers also supported by the UE is to be reactivated, wherein the handling of the one or more secondary carriers was deactivated at the UE when the primary carrier entered the DRX mode; and
an activation component configured to activate, at the UE, handling of the one or more secondary carriers in response to the determining the indication.

20. The apparatus of claim 19, wherein the indication is that a size of the received data is greater than a size threshold.

21. The apparatus of claim 19, wherein the indication is a high speed shared control channel (HS-SCCH) order.

22. The apparatus of claim 19, wherein the indication includes a logical channel identifier that indicates to the UE to activate the one or more secondary carriers.

23. The apparatus of claim 19, wherein the indication includes one or more padding bits that indicate to the UE to activate the one or more secondary carriers.

24. The apparatus of claim 19, wherein the indication includes a header element that indicates to the UE to activate the one or more secondary carriers.
